(19) United States
(12) Patent Application Publication
(10) Pub. No.: US 2013/0254561 A1
(43) Pub. Date: Sep. 26, 2013

(54) POWER SUPPLY DEVICE

(71) Applicants: Hong Fu Jin Precision Industry (ShenZhen) Co., LTD., (US); HON HAI PRECISION INDUSTRY CO., LTD., New Taipei (TW)

(72) Inventors: KANG WU, Shenzhen (CN); GUO-YI CHEN, Shenzhen (CN); WEI-DONG CONG, Shenzhen (CN)

(73) Assignees: HON HAI PRECISION INDUSTRY CO., LTD., New Taipei (TW); Hong Fu Jin Precision Industry (ShenZhen) Co., LTD., Shenzhen (CN)

(21) Appl. No.: 13/832,014

(22) Filed: Mar. 15, 2013

(30) Foreign Application Priority Data
Mar. 20, 2012 (CN) 201210074136.8

(51) Int. Cl. G06F 1/26

(52) U.S. Cl. CPC G06F 1/26
USPC 713/300

(57) ABSTRACT

A power supply device used to provide electric power to a number of servers includes a first power supply and a selection circuit. The selection circuit includes a number of NOT gates, a number of controllers, and a number of transistors. An input terminal of each NOT gate is electrically connected to one of the corresponding servers. Each controller is electrically connected an output terminal of one corresponding NOT gate. A gate of each transistor is electrically connected to one of the corresponding controller, a drain of each transistor is electrically connected to the first power supply, and a source of each transistor is electrically connected to one of the corresponding server. Wherein when some of the server is powered on, the powered on servers generate power on signals which are transmitted to the corresponding controllers, the controllers generates corresponding turn on signals to turn on the corresponding transistors.

### BACKGROUND

1. Technical Field

The disclosure generally relates to power supply devices, and particularly to a power supply device applied to a server system.

2. Description of Related Art

Many computer systems can operate using multiple servers. For example, a 4-in-1 2U server system includes four servers sharing a hard disk backplane. Each server can control multiple hard disks using the hard disk backplane to observably increase a data processing ability of the system. Because each server commonly independently works, each server must include a corresponding independent power supply which cannot be influenced by power supplies of other servers. However, if a special power supply is configured for each server, the server system is complicated and cost of the server system is also increased.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a block diagram of a power supply device, according to an exemplary embodiment of the disclosure.

FIG. 2 is a circuit diagram of a control circuit of the power supply device of FIG. 1, according to the exemplary embodiment of the disclosure.

FIG. 3 is a circuit diagram of a selection circuit of the power supply device of FIG. 1, according to the exemplary embodiment of the disclosure.

### DETAILED DESCRIPTION

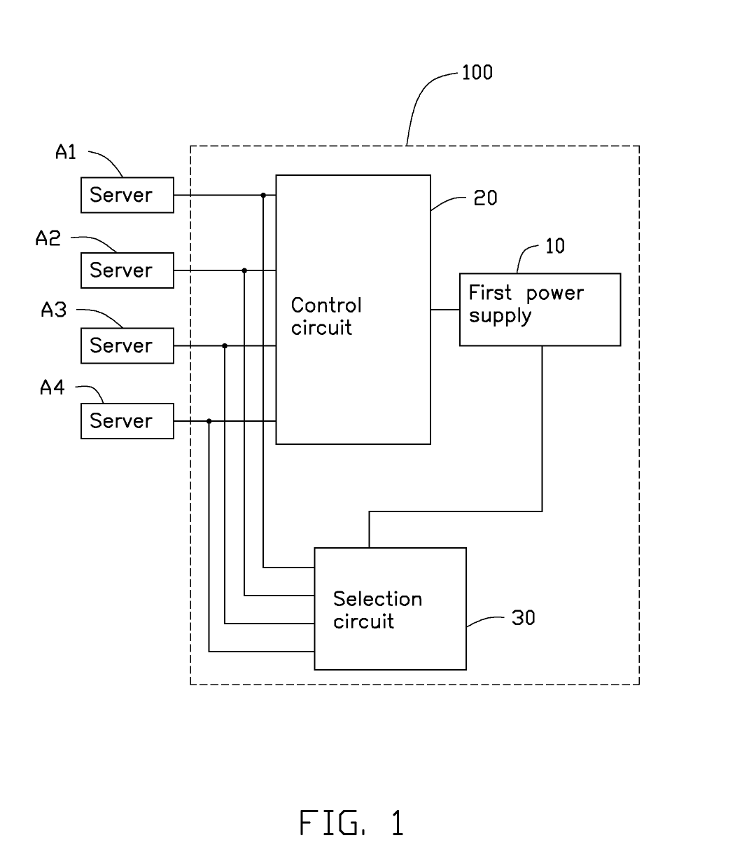

FIG. 1 is a block diagram of a power supply device 100, according to an exemplary embodiment of the disclosure. The power supply device 100 is used in a computer system comprising multiple servers to provide electrical power for the servers. In this exemplary embodiment, the power supply 100 is used in a 4-in-1 2U server system. The 4-in-1 server system includes four servers A1-A4. The power supply device 100 selectively provides electrical power to some of the four servers A1-A4.

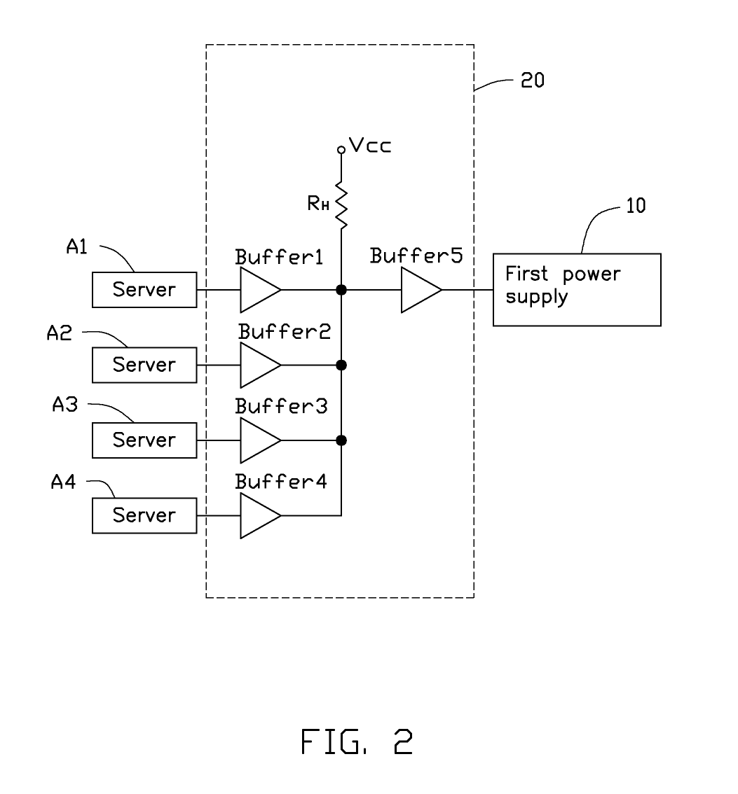

In FIG. 2, the power supply device 100 includes a first power supply 10, a control circuit 20, and a selection circuit 30. The first power supply 10 may be a battery or an adapter connected to a power supply. The control circuit 20 includes four first buffers Buffer1-Buffer 4 corresponding to the servers A1-A4, a pull-up resistor R_{H} and a second buffer Buffer5. An input terminal of each first buffer Buffer1-Buffer4 is electrically connected to one of the corresponding servers A1-A4. An output terminal of each first buffer Buffer1-Buffer4 is connected together and also electrically connected to a second power supply Vcc by the pull-up resistor RH. An input terminal of the second buffer Buffer5 is electrically connected to the output terminals of the first buffers Buffer1-Buffer4. An output terminal of the second buffer Buffer5 is electrically connected to the first power supply 10.

In one exemplary embodiment, the servers A1-A4 are set as generating a preset high level voltage signal (i.e. logic 1) in a power off or standby state and generating a preset low level voltage signal (i.e. logic 0) as a power on signal when the servers A1-A4 are powered on. Thus, when some of the servers A1-A4 are powered on, the corresponding power on signals are generated by the powered on servers A1-A4, and then input to the corresponding first buffers Buffer1-Buffer4 and the second buffer Buffer5, and finally output to first power supply 10 to activate the first power supply 10.

In other embodiment, the second buffer Buffer5 can be omitted, the output terminals of the first buffers Buffer1-Buffer5 are directly connected to the first power supply 10.

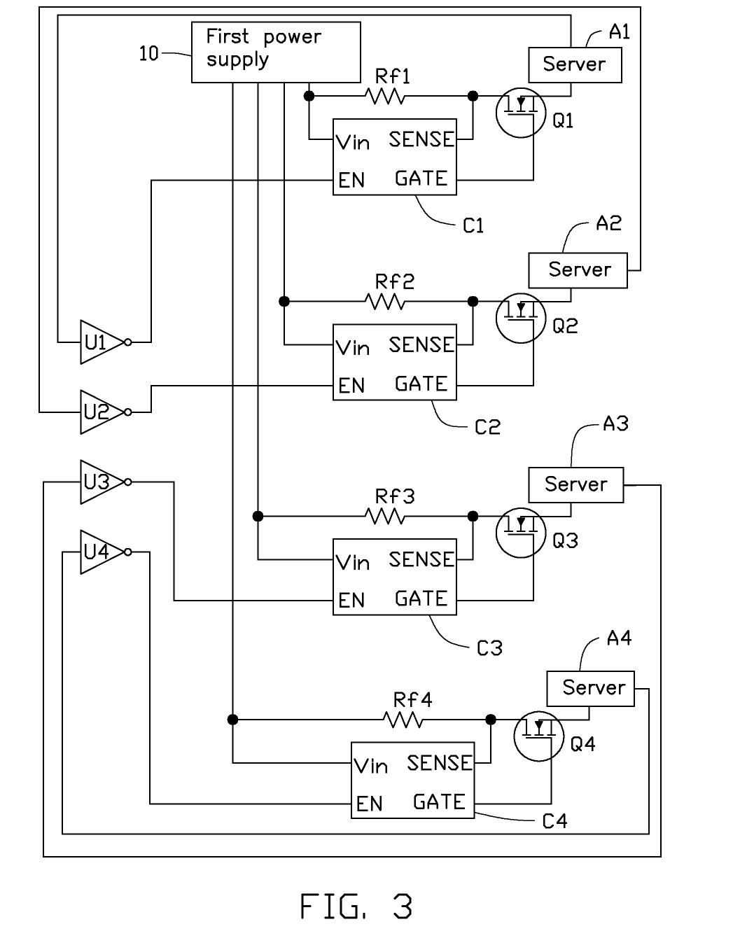

In FIG. 3, the selection circuit 30 includes four NOT gates U1 corresponding to the servers A1-A4, four controllers C1, four sampling resistors Rf1-Rf4, and four transistors Q1-Q4.

An input terminal of each NOT gate U1 is electrically connected one of the corresponding servers A1-A4. An output terminal of each NOT gate U1 is electrically connected to one of the corresponding controllers C1.

The controllers C1 may be an LM25066-typed integrated microchip in one embodiment. Each controller C1 includes a power supply contact Vin, an enable contact EN, a current sensing contact SENSE, and a driving contact GATE. The power supply contact Vin is electrically connected to the first power supply 10. The enable contact EN is electrically connected to the output terminal of one NOT gate U1. The current sensing contact SENSE is electrically connected to the first power supply 10 by one of the corresponding sampling resistors Rf1-Rf4. The transistors Q1-Q4 are metal-oxide-semiconductor field-effect transistors (MOSFETs). A gate of each transistor Q1-Q4 is electrically connected to the driving contact GATE. A source of each transistor Q1-Q4 is electrically connected to one of the servers A1-A4. A drain of each transistor Q1-Q4 is electrically connected to the current sensing contact SENSE of one of the controllers C1-C4.

According to characteristics of the controllers C1-C4, when the enable contact EN of one of the controllers C1-C4 is at a high level (i.e. logic 1), the corresponding controller C1-C4 is enabled. The enabled controller C1-C4 outputs a turn on signal to one of the transistors Q1-Q4. The corresponding transistor Q1-Q4 is turned on. Thus, one of the corresponding servers A1-A4 is electrically connected to the first power supply 10 and obtains the electric power from the first power supply 10. The current sensing contact SENSE obtains current output from the first power supply 10 by the sampling resistor Rf1-Rf4. Once the sensed current exceeds preset current, the controller C1-C4 outputs a turn off signal to the transistor Q1-Q4 to disconnect the server A1-A4 from the first power supply 10 and protects the server A1-A4 from damages due to over-current.

When the servers A1-A4 are in the power-off state or the standby state, the high level voltages (logic 1) are input to the first buffers Buffer1-Buffer4 and the second buffer Buffer5, and finally output to the first power supply 10. The first power supply 10 is inactivated.

When at least one of the servers A1-A4 is powered on, the powered on server A1-A4 generates an power on signal, such as low level voltages (logic 0). The power on signals are input to the first power supply 10 by the first buffers Buffer1-Buffer4 and the second buffer Buffer5. Thus, the first power supply 10 is activated.

In addition, the low level voltages generated by the powered on servers A1-A4 are also input into the corresponding NOT gates. The corresponding NOT gates output the corresponding high level voltage to enable the corresponding controllers C1-C4. The enabled controllers C1-C4 generates the turn on signals to turn on the corresponding transistors Q1-Q4 so that the powered on servers A1-A4 are electrically connected to the first power supply 10 and obtain the electric power from the first power supply 10. Moreover, when the controllers C1-C4 sense that the current output the first power supply 10 exceeds the preset current, the controller C1-C4 outputs a turn off signal to the transistor Q1-Q4 to disconnect the server A1-A4 from the first power supply 10 to protect the server A1-A4.

In other embodiments, the number of the first buffers, the NOT gates, the controller and the transistors can be changed according to the number of the servers.

The power supply 100 can serve as a power source for the multiple servers A1-A4 and selectively provide electric power to some of the servers A1-A4. Each server can be independently power supplied by the power supply 100 without a special power supply. The server system has a simple structure and costs less.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A power supply device used to provide electrical power to a plurality of servers, the power supply comprising:
a first power supply; and
a selection circuit, comprising:
a plurality of NOT gates corresponding to the servers, an input terminal of each of the NOT gates electrically connected to one of the corresponding servers;
a plurality of controllers corresponding to the NOT gates, each controller electrically connected to an output terminal of one corresponding NOT gate; and
a plurality of transistors corresponding to the controllers, a gate of each transistor electrically connected to one of the corresponding controller, a drain of each transistor electrically connected to the first power supply, and a source of each transistor electrically connected to one of the corresponding server; wherein when at least one of the servers is powered on, the powered on server generates a power on signal, the power on signal is transmitted to the corresponding controller by the NOT gate, the controller turns on the corresponding transistors.

2. The power supply device of claim 1, further comprising a control circuit, wherein the control circuit comprises a plurality of first buffers corresponding to the servers and a pull-up resistor; an input terminal of each first buffer is electrically connected one of the corresponding servers, an output terminal of each first buffer is connected together and also electrically connected to a second power supply by the pull-up resistor, the power on signals are output to the first power supply by the first buffers and activate the first power supply.

3. The power supply device of claim 2, wherein the control circuit further comprises a second buffer, an input terminal of the second buffer is electrically connected to the output terminals of the first buffers, and an output terminal of the second buffer is electrically connected to the first power supply.

4. The power supply device of claim 1, wherein each controller comprises an enable contact, the enable contact is electrically connected to the output terminal of one of the corresponding NOT gate, the powering signals are transmitted to the corresponding enable contacts by the corresponding NOT gate to enable the corresponding controllers.

5. The power supply device of claim 4, wherein each controller comprises a gate contact, the gate contact is electrically connected to the gate of one of the corresponding transistor, the turn on signals are transmitted to the corresponding gate contacts to turn on the corresponding transistors.

6. The power supply device of claim 5, wherein each controller comprises a current sensing contact, the selection circuit further comprises a plurality of sampling resistors corresponding to the servers, the current sensing contact is electrically connected to the first power supply by one of the corresponding sampling resistors, the current sensing contact obtains current output from the first power supply by the sampling resistor, when the sensed current exceeds preset current, the controller outputs a turn off signal to the transistor to disconnect the server from the first power supply.

7. A power supply device used to provide electrical power to a plurality of servers, the power supply comprising:
a first power supply; and
a selection circuit electrically connected between the servers and the first power supply, wherein when at least one of the servers is powered on, the selection circuit selects the powered on servers to obtain electrical power from the first power supply.

8. The power supply device of claim 7, wherein the selection circuit comprises a plurality of NOT gates corresponding to the servers, a plurality of controllers corresponding to the NOT gates, and a plurality of transistors corresponding to the controllers; an input terminal of each NOT gate is electrically connected to one of the corresponding servers, an output terminal of each NOT is electrically connected one of the corresponding controllers; a gate of each transistor electrically connected to one of the corresponding controller, a drain of each transistor electrically connected to the first power supply, and a source of each transistor electrically connected to one of the corresponding server; when the at least one server is powered on, the powered on servers generate power on signals, the power on signals are transmitted to the corresponding controllers by the NOT gates, the controllers generates corresponding turn on signals to turn on the corresponding transistors.

9. The power supply device of claim 7, further comprising a control circuit, wherein the control circuit comprises a plurality of first buffers corresponding to the servers and a pull-up resistor an input terminal of each first buffer is electrically connected one of the corresponding servers, an output terminal of each first buffer is connected together and also electrically connected to a second power supply by the pull-up resistor, the power on signals are output to the first power supply by the first buffers and activate the first power supply.

10. The power supply device of claim 9, wherein the control circuit further comprises a second buffer, an input terminal of the second buffer is electrically connected to the output terminals of the first buffers, and an output terminal of the second buffer is electrically connected to the first power supply.
